(19) United States
(12) Patent Application Publication
(10) Pub. No.: US 2007/0235390 A1
(43) Pub. Date: Oct. 11, 2007

(54) Titanium-coated sorbents as a separation medium for HPLC of phosphorus-containing materials

(76) Inventors: Barry E. Boyes, Wilmington, DE (US); James D. Martosella, Downingtown, PA (US); Susanne C. Moyer, Newark, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/402,029

(22) Filed: Apr. 10, 2006

(51) Int. Cl. G01N 1/18

(52) U.S. Cl. 210/656; 435/7.1; 436/177

(57) ABSTRACT

Methods for the separation of phosphorus-containing biological materials from a sample mixture are provided. The methods use a solid support comprising a Ti(IV) metal-coated sorbent matrix. Methods using the support as a chromatographic column for separation are also provided. The present disclosure also provides methods for making a Ti(IV) metal-coated sorbent.

### REFERENCE TO RELATED APPLICATIONS

This application is a nonprovisional application and is related to, and claims priority to, copending U.S. nonprovisional applications Ser. Nos. [not yet known], filed evendate herewith, and entitled “Metal-coated Sorbents as Separation Medium for HPLC of Phosphorus-containing Materials,” and “Metal-coated Superficially Porous Supports as Medium for HPLC of Phosphorus-containing Materials,” the disclosures of which are incorporated herein by reference in their entirety.

### BACKGROUND

Interest in proteomics analysis has increased dramatically over the past several years. The biological systems used in proteomics analysis are often very complex, containing mixtures of different chemical compounds present at different concentrations, such as proteins. Of particular interest are phosphorylated proteins and nucleotides, which play an important role in cell signaling. Therefore, effective isolation, detection and separation of such compounds are necessary. Multi-dimensional separation techniques such as liquid chromatography, including high-performance liquid chromatography (HPLC), are typically used for such separations.

Immobilized metal affinity chromatography (IMAC) has been used for the selective binding of proteins, as explained in Porath et al., A New Approach to Protein Fractionation, Nature, 258: 598-599 (1975). This technique is based on interaction between an electron-donating group on a protein surface, and a metal cation with one or more accessible coordination sites. The metal ion, in turn, is attached to a metal-chelating groups attached to a solid matrix or support.

The ligands used in IMAC are usually tri-, tetra-, or pentadentate, providing metal chelation to the ligand bound on the solid support, while maintaining additional free sites for coordination of the metal with the analyte. For example, a widely used form of IMAC used Ni(II)-chelated ligand for the selection and purification of His-tagged proteins. Here, Ni²⁺ coordinates with imidazole on the histidine side chain, allowing for purification of recombinant proteins with a His-6 tag.

Selective coordination of a particular metal with a specified functional group is dependent on pH. In a typical IMAC experiment, metal ions are loaded onto a chelating solid support, followed by binding of the target analyte (such as a phosphopeptide) to the metal ion. Changes in pH affect the electron donor-acceptor properties of the analyte and metal. For example, with phosphorylated compounds, optimal binding occurs at very low pH (typically <3.5). However, even at such low pH values, interference from other charged groups such as the carboxylic acid moieties of aspartic and glutamic acid residues may still be possible. As the pH is lowered, the ligand that coordinates the metal becomes protonated, and therefore, the negative charge used to non-covalently coordinate the ligand with the positive charge on the metal is eliminated. This causes a loss of the metal chelated to the solid support and a consequent loss of the ability for the solid support-bound ligand to capture phosphate. If, on the other hand, the pH is increased to avoid protonation of the ligand and preserve phosphate-binding ability, deprotonated carboxylic acid moieties (pKₐ˜3.5) also bind to the metal, reducing the utility of the metal-coordinated solid support for selective separation of phosphorus-containing proteins. Problems with metal ion dissociation from the chelating solid support and its subsequent contamination of the separated biological product have also been observed in IMAC.

### SUMMARY

The present disclosure generally relates to methods for separating phosphorus-containing materials, including materials such as proteins, polypeptides, polynucleotides, phosphopeptides, their chemical or synthetic equivalents, or combinations thereof, from a sample mixture. In embodiments, the disclosure provides methods for separating a target phosphorus-containing biological material from a sample using a solid support comprising a sorbent matrix coated with titanium or titanium metal.

Methods for separating phosphorus-containing compounds from a sample mixture are provided. The sample mixture is contacted with a solid support comprising titanium or titanium metal coated onto a sorbent matrix, the combination of which is needed for phospho selection. The phosphorus-containing material is captured on the support, or collected in the pass-through fraction. The ability of the titanium-coated support to selectively bind to phosphorus-containing compounds can be controlled by varying the pH during separation.

Methods for the preparation of a titanium-coated or titanium metal-coated sorbent support are also described herein. Titanium metal is selected, because of its affinity for binding phosphorus-containing compounds. The sorbent matrix is coated with titanium or titanium metal by either covalent or non-covalent means to form the solid support.

### DETAILED DESCRIPTION

Various embodiments of the present disclosure will be described in detail. Reference to various embodiments does not limit the scope of claims attached hereto. Additionally, any examples set forth in this specification are not intended to be limiting and merely set forth some of the many possible embodiments of the claims.

Unless defined otherwise, all technical and scientific terms used herein have the same meaning as commonly understood by one of ordinary skill in the art. Although any methods and materials similar or equivalent to those described herein can also be used in the practice or testing of the present disclosure, the methods and materials are now described. Methods recited herein may be carried out in any order that is logically possible, in addition to a particular order disclosed.

In this specification and the appended claims, the singular forms “a,” “an,” and “the” include plural reference, unless the context clearly dictates otherwise. Unless defined otherwise, all technical and scientific terms used herein have the same meaning as commonly understood too one of ordinary skill in the art.

Titanium-Coated Supports

The present disclosure is directed to a titanium-coated support material where titanium metal is incorporated onto a sorbent particle. The titanium-coated support has high affinity for phosphorus-containing materials, including biological materials, such as proteins and nucleotides. The titanium-coated supports are stable over a wide range of pH values.

The sorbent particle or sorbent matrix is any particle or matrix that can take up and hold titanium, and is stable under the conditions used for applying the titanium coating. In an embodiment, the sorbent surface is reactive or derivatized for coating with titanium. In a further embodiment, suitable materials for the sorbent include alumina, silica, polymers, carbon, zirconium, controlled pore glass, diatomaceous earth, or combinations thereof. In certain embodiments, the sorbent particle is suitable for use in chromatography. In an embodiment, the sorbent particle is part of a support used for chromatography. For the purposes of this disclosure, the term “sorbent” refers to a type of chromatographic support material, and the terms “sorbent” and “support” are used interchangeably.

The shape of the sorbent particle is not critical and is determined by application. Suitable shapes include, but are not limited to, spheres, ellipsoids, rings, polyhedra, saddles, platelets, fibers, hollow tubes, rods and cylinders. Sorbent particles with regular geometry are generally compatible with chromatographic applications. In an aspect, the sorbent particle has a spherical shape, but geometric perfection of the spherical shape is not critical.

The titanium or titanium metal coating is formed from titanium-derived compounds. Common compounds used to form the titanium metal coating include, but are not limited to, titanium metal, including Ti(IV), titanium alkoxides, titanium halides, titanium oxides, titanium hydroxides and/or titanium metal salts. In an embodiment, the coating material is titanium metal in the Ti(IV) coordination state. In a further embodiment, the coating material is titanium metal having anastase and/or rutile crystalline structures. For the purpose of this disclosure, the term “titanium metal” refers to titanium metal and encompasses the Ti(IV) coordination state and the anastase or rutile crystalline structures of titanium metal. The term “titanium” encompasses various titanium-based compounds such as titanium oxides, titanium alkoxides, titanium halides, titanium hydroxides and/or titanium salts, etc.

The titanium or titanium metal is coated on the sorbent particle through either covalent or non-covalent interactions including, but not limited to, electrostatic, ionic, adsorptive, absorptive, and chemically adhered coatings. In various embodiments, the coating is applied by chemical, physical and/or electrical deposition (adsorption or absorption), cladding, welding, grafting, fusing, sintering, or combinations thereof. In an embodiment, the titanium coating is applied in one or more process steps. In a further embodiment, the processes may use intermediate metallic and non-metallic titanium-based compounds or agents to achieve the titanium coating. In various embodiments, the coating is incorporated into, onto, and/or throughout the matrix of the sorbent particle. The terms “coating” and “coated” refer to the covering of the sorbent by metal and include incorporation of the metal either into, or onto, the sorbent. Coating can be accomplished by any of the methods discussed herein. The term “cladding” refers to the formation of a layer of metal on the surface of the sorbent matrix. For the purposes of this disclosure, the terms “cladding” and “coating” are used interchangeably. For the purposes of this disclosure, the terms “cladding” and “coating” exclude cladding or coating by coordination of a metal ion to ligand. In an embodiment, the coating consists of an outer monolayer of Ti(IV) metal. In another embodiment, the coating consists of monolayers. An example of a method for coating a particular sorbent with titanium is taught in Gushikem et al., J. Braz. Chem. Soc. 12: 695-705 (2001); Tan et al., J. Catal. 129, 447-56 (1991); and Choi et al., App. Surf. Sci. 240: 7-12 (2005), the disclosures of which are incorporated herein by reference.

The present description provides a support comprising a sorbent matrix coated with titanium. In one embodiment, the sorbent is coated with a layer of Ti(IV) metal. In another embodiment, the support consists of a silica sorbent particle coated with a monolayer of titanium oxide (titania or TiO₂).

The titanium-coated supports have an average particle diameter of about 2 to about 50 μm, for example, 5 μm. In one embodiment, the support comprises coated silica particles with an average particle diameter of about 3 μm to about 10 μm.

In embodiments, the titanium-coated or titanium metal-coated supports have pores, the size of the pores being selected to suit the desired biological material to be separated from the sample. In one aspect, the average pore size is greater than or equal to about 300 Å. For example, a support used for the separation of larger biological molecules like proteins requires a pore size larger than 200 Å. In other aspects, the pore size of the titanium-coated support may be less than 300 Å. For example, smaller molecules like drug molecules can be separated using supports with pore sizes in the 40-100 Å range.

The titanium-coated or titanium metal-coated support may be used in any of a variety of configurations and techniques. The titanium-coated or titanium metal-coated support is suitable for use in a variety of separation techniques including, but not limited to, liquid chromatography. Examples of suitable configurations include columns, spin devices, membranes, semi-permeable membranes, beds, molecular sieves, powders, granulates, and fibers.

In one embodiment, the titanium-coated or titanium metal-coated support is used for the separation of particular types of biological material from a sample. Such supports are used for the selective separation of phosphorus-containing materials from a sample. In an aspect, the titanium-coated or titanium-metal coated supports are useful for the selective separation of phosphorus-containing materials from a sample also containing carboxylic acid-containing materials. In certain embodiments, the phosphorus-containing materials are biological molecules, such as phosphorylated proteins, nucleic acids, phosphopeptides, etc.

In various embodiments, titanium-coated or titanium metal-coated supports are incorporated into various configurations, including chromatography columns, filters, membranes, spin devices, or free-flowing powders. In an embodiment, the support is used as the stationary phase in liquid chromatography. In a further embodiment, the support is selective for the capture and binding of phosphorus-containing compounds, in liquid chromatography experiments. In one aspect, when used as a column packing material, the support shows improved analyte binding kinetics and efficiency when compared to IMAC stationary phases with analogous particle characteristics.

A sample is typically any mixture of biological material including, but not limited to, proteins, nucleotides, and their modified and/or processed forms. The sample can be derived from biological fluid (such as blood, plasma, serum, urine, tears, etc., for example). The sample can also be obtained from a variety of sources including, without limitation, cell samples, organisms, subcellular fractions, etc. In one aspect, the biological material is a phosphorus-containing compound, including, without limitation, phosphoric esters, phosphates, phosphonates, phosphoric anhydrides, phosphodienes, nucleoside triphosphate analogs, phosphoric amides, fluorophosphoric acids, etc. In another aspect, the biological material is a phosphorylated compound, i.e. a chemical compound to which a phosphate group has been added by the action of an enzyme such as a phosphorylase or a kinase. Phosphorylated compounds include, without limitation, proteins, polypeptides, phosphopeptides, lipids, glycans, nucleotides, nucleosides, polynucleotides, small molecule drugs that mimic nucleotides or polynucleotides, etc.

In embodiments, the sorbent is coated with a layer of Ti(IV) metal for the selection of phosphopeptides. Basic molecules (like organic phosphates) are strongly adsorbed on the surface of metals like Ti(IV). The affinity of certain metal ions for organic phosphates has been described in the literature and is based on HSAB theory. Phosphorus-containing compounds are hard Lewis bases which show greatest affinity for binding with metal ions that acts as hard Lewis acids, such at Ti⁴⁺. See Ueda et al., J. Chromatography A. 988: 1-23 (2003) (describing use of Fe(III)-IMAC). The use of titanium oxide as a chemoaffinity support is advantageous over traditional IMAC procedures, because it eliminates the need to load the chelating chromatographic support with metal and the associated problem of metal dissociation from the chelating support.

Methods for Coating Titanium onto a Sorbent

In embodiments, titanium metal is coated onto the sorbent by adsorption and/or absorption. In an aspect, titanium metal is directly adsorbed and/or absorbed onto the surface of the sorbent particle, with no intermediate compounds lying between the metal layer and the surface of the porous particle, and no intermediate compounds used to coordinate the metal to the sorbent. In an embodiment, the metal is permanently attached to the sorbent. In another embodiment, a thin layer of TI(IV) metal is coated or clad by welding, or fusing onto a silica sorbent. Incorporation of this type may be accomplished by, for example, electrochemical deposition of Ti (IV) metal. In another aspect, the metal may be incorporated onto the sorbent surface through vapor deposition. In yet another aspect, the metal can be incorporated onto the sorbent by impregnation of the support with a metal salt, followed by hydrolysis and calcination. For example, a process for coating silica with a thin layer of titanium oxide for use as a catalytic support is taught in Tan et al., J. Catal. 129: 447-56 (1991). Briefly, TiCl₄ is added to dry silica and the mixture is heated, followed by evaporation and hydrolysis. The amorphous oxide layer is then calcined to produce a crystalline monolayer on the silica surface. Grafting of metal oxide thin films onto silica for use in HPLC has also been reported by Silva et al., J. Chromatography A 845: 417-22 (1999).

In a further embodiment, the titanium metal is incorporated onto the sorbent matrix by a sol-gel process. In an embodiment, a thin monolayer of Ti(IV) metal is permanently deposited onto the sorbent without altering the morphology or characteristics of the support. In one aspect, nearly linear or branched soluble oligomers (or sols) of titanium alkoxides are combined with the sorbents by dipping or spinning to form the titanium-coated support. The titanium metal films formed in this way can be annealed at low temperature to produce dense and crystalline monolayers of metal on the sorbent surface. Titanium oxide films formed on spherical silica particles using this method were disclosed in Retuert et al., J. Mat. Chem 10: 2818-22 (2000). The sol-gel coating process provides reproducible compositions and coatings with reproducible thickness.

Methods for Separation of Biological Material using Titanium-Coated Sorbents

The disclosure herein provides methods for separation of a phosphorus-containing biological material using a titanium-coated or titanium metal-coated sorbent. The titanium-coated or titanium metal-coated sorbent is contacted with the sample mixture to capture the phosphorus-containing biological material on the sorbent or support. In an embodiment, Ti(IV) metal, which has a high affinity for organic phosphates, is chosen for the selective separation of phosphorylated compounds such as, for example, nucleotides, polynucleotides, glycans, lipids, proteins and polypeptides. The Lewis acid sites on Ti(IV) act as suitable binding partners for phosphorylation sites on proteins and peptides. The affinity of certain metal ions for organic phosphates is based on Hard and Soft Acid/Base (HSAB) theory, as described in Pearson et al., J. Am. Chem. Soc. 85: 3533-39 (1963). Phosphorus-containing compounds are hard Lewis bases which show greatest affinity for binding with metal ions that acts as hard Lewis acids, such at Ti⁴⁺.

In an embodiment, the pH at which the separation is performed can be varied. In an aspect, the pH range can be adjusted to optimize phosphate binding to the Ti(IV)-coated sorbent or solid support, while minimizing carboxylic acid binding (from aspartic and glutamic acid residues), as a way of selectively separating phosphorylated compounds. The phosphorus-containing material captured on the solid support can be further separated by standard elution procedures. In another aspect, the phosphorus-containing material captured on the support may be a contaminant, and by retaining this contaminant on the solid support, the other components in the sample mixture, now free of phosphorus-containing compounds, can be collected in the pass-through fractions. Unlike IMAC, the titanium metal remains non-covalently attached to the sorbent surface at all pH values. In an embodiment, separation is carried out in the pH range of approximately 1-3, which is optimal for capturing phosphorylated compounds on the Ti(IV)-coated support.

In embodiments, the pH can be modified to a desired value using a buffer, appropriately pH-adjusted. Buffer systems are known and generally include one or more basic compounds and their conjugate acids, such as sodium acetate, or with the addition of acids, such as acetic acid and trifluoroacetic acid. Other example buffer systems include, but are not limited to, maleate, glycine, citrate, formate, succinate, and acetate.

Biological material captured on the surface of the titanium-coated or titanium-metal coated support can then be separated from the support using standard elution procedures and techniques known to those of skill in the art. In an aspect, the elution removes the biological material without affecting either the titanium cladding or coating, or the sorbent. The titanium coating remains bound to the sorbent during the elution process. Elution of phosphorylated compounds from the solid support can be accomplished using buffers, such as those containing phosphate salts or ammonium hydroxide.

Phosphorus-containing compounds separated using a titanium-coated sorbent can be detected and/or quantitated and/or further characterized to determine their properties (e.g., amino acid sequence, mass/charge ratio, etc). In one aspect, separated proteins or peptides can be analyzed by a proteomics analysis method, such as, for example, two-dimensional gel electrophoresis. In another aspect, separated proteins can be analyzed by mass spectrometry methods including, but not limited to, MALDI-TOF MS, ESI, TOF, ion trap MS, ion trap/TOF MS, quadrupole mass spectrometry, FT-MS, fast atomic bombardment (FAB), plasma desorption (PD), thermospray (TS), magnetic sector mass spectrometry, etc. The separated proteins or peptides may also be analyzed by NMR and other techniques. The separated proteins or peptides may be analyzed collectively, or individually, to identify proteins.

In embodiments, prior to separation on a titanium-coated sorbent, the sample can be contacted with an immunoaffinity stationary phase to enrich the sample with one or more types of protein or protein fragments. In other aspects, proteins may also be contacted with a cleaving agent such as, for example, trypsin, to generate peptides. The cleaving step may also be carried out after separation on a metal-coated sorbent support.

The various embodiments described above are provided by way of illustration only and should not be construed to limit the claims. Those skilled in the art will readily recognize various modifications and changes that may be made to the present methods without following the example embodiments and applications illustrated and described herein, and without departing from the true spirit and scope f the present claims.

1. A method for separating one or more phosphorus-containing biological materials from a sample, comprising:
contacting the sample to a support comprising a sorbent coated with Ti(IV) metal; and
capturing one or more phosphorus-containing biological material on the support; or
collecting one or more phosphorus-containing biological material in the pass-through fraction,
wherein one or more phosphorus-containing materials are captured on the support or collected in the pass-through fraction, but other components of the sample mixture are not captured or collected.

2. The method of claim 1, wherein capturing the phosphorus-containing biological material on the support further comprises varying the pH to promote binding of the biological material to the support.

3. The method of claim 1, wherein the sample comprises one or more of lipids, amino acids, peptides, proteins, nucleosides, sugars, oligosaccharides, or mixtures thereof.

4. The method of claim 1, wherein the phosphorus-containing material comprises one or more of a lipid, amino acid, peptide, protein, sugar, or oligosaccharide present in a sample.

5. The method of claim 1, wherein the support is part of a column, spin tube, coated membrane, or powder.

6. The method of claim 2, wherein the pH is varied between the range of pH 1.0 to pH 3.0 to optimally bind phosphopeptides to Ti(IV) metal.

7. A method for preparing a support for selective separation of a phosphorus-containing material from a sample, comprising the steps of:
providing a sorbent matrix;
selecting titanium metal for binding phosphorus-containing material; and
coating the sorbent matrix with titanium metal to form the support.

8. The method of claim 7, wherein the coating of titanium metal onto the sorbent matrix is by covalent methods.

9. The method of claim 7, wherein the coating of titanium metal onto the sorbent matrix is by non-covalent methods.

10. The method of claim 7, wherein the sorbent matrix comprises silica.
